(19) United States
(12) Patent Application Publication
(10) Pub. No.: US 2006/0068074 A1
(43) Pub. Date: Mar. 30, 2006

(54) Shelf stable gelatinous product

(76) Inventor: Roland E. Stefandl, Princeton, NJ (US)

Correspondence Address: Leopold Presser;Scully, Scott, Murphy & Presser, Suite 300, 400 Garden City Plaza, Garden City, NY, 11530, US

(21) Appl. No.: 10/955,132

(22) Filed: Sep. 30, 2004

(51) Int. Cl. A23L 1/05

(52) U.S. Cl. 426/573

(57) ABSTRACT

The present invention provides a gelatin product that is shelf stable at room temperatures, completely vegetable-based, nutritionally beneficial to the consumer, able to meet restrictive religious dietary requirements, convenient and enjoyable to eat. The gelatin consists water held in a molecular network of carrageenan polysaccharide chains, cross-linked by ions in solution with the water. An iota form of carrageenan is particularly suitable for the gel formulation. Calcium ions are also particularly suitable for the gel formulation.

### BACKGROUND OF THE INVENTION

1. Field of Invention

The invention relates to the field of prepared food products, and more particularly, to a gelatinous product that solidifies at ordinary room temperatures.

2. Description of Related Art

Gelatin food products are old and well known. A common formulation uses an animal byproduct, tallow, typically derived from beef or pork, to form a gelatinous base that is dissolved in water. Often, additives such as color, flavor, and/or sweeteners are included. After fully dissolving the mixture in solution, it must be cooled to form into a solid gel, and maintained until consumption at a temperature sufficient to prevent the gel from returning to a liquid state.

This formulation has certain drawbacks. One is the use of animal products in the formulation. For reasons of health, religious observance, or personal choice, individuals are more often choosing to avoid consuming animal products. Another drawback is the need to refrigerate the gelatin in order to assume a solid form, and to be held at low temperature to maintain solid gel form.

Various alternatives to animal-based gelatins are known in the art. For example, carrageenan, a long-chain polysaccharide molecule derived from kelp, has shown some utility as a gelatinous base. However, carrageenans by themselves have proven insufficient to hold a gelatin, at room temperature, in a solid state. For example, one known embodiment utilizes a kappa form of carrageenan, in combination with potassium, specifically tri-potassium citrate. However, locust bean gum must be added to achieve suitable gelling characteristics. However, there are certain disadvantages in using locust bean gum in gelatin formulations. At least one of these is the high cost and limited availability of locust bean gum as an ingredient.

Other water-soluble vegetable-based gelling agents are known, for example pectin, often derived from fruit products. However, these are also considered undesirable in a gelatin product as contemplated by the present invention.

### BRIEF SUMMARY OF THE INVENTION

In order to overcome these and other drawbacks in the prior art, provided according to the present invention is an improved gelatin food product formulation, and method for producing the same.

In one aspect, the present invention is directed to a gelatin food product formulation consisting essentially of at least about 73.8% wt. water, at least about 0.6% wt. carrageenan, and at least about 0.57% wt. ionizing salt. In another aspect of the present invention, one or more non-essential additives, a non-exhaustive list of which includes natural or artificial sweeteners, colors, flavors can optionally be included without materially altering the gel. According to another aspect of the present invention, a gel consists essentially of water, carrageenan, and calcium in a ratio of at least about 1520:12.6:1 by weight. While both kappa and iota forms of carrageenan are known to form gels, the iota form is particularly suitable for the gel formulation.

### BRIEF DESCRIPTION OF THE DRAWINGS

These and other features, advantages and benefits of the present invention will be made apparent with reference to the following specification and accompanying figures, wherein:

FIG. 1 illustrates the chemical structure of repeating units in a variety of limit carrageenans; and

FIGS. 2A, 2B, and 2C are a tabular representation of various formulations of a shelf stable gelatin including certain embodiments of the present invention.

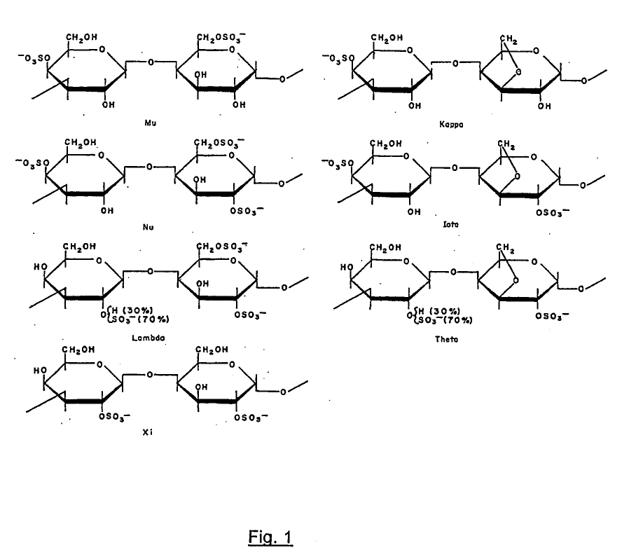

### DETAILED DESCRIPTION OF THE INVENTION

It was discovered in testing that the iota form of carrageenan in combination with calcium achieves favorable results. Kappa carrageenan also formed a gel, though results were less favorable than iota. For example, gels formed using iota exhibited little to no syneresis. In order to achieve a desirable consistency, the ratio of water to fibrous carrageenan should be at least about 120:1 by weight. Alternately, according to a preferred embodiment, liquid carrageenan extract of at least 1% by weight can be used. Using carrageenan extract as opposed to fibrous carrageenan also has the added benefit of reducing the carbohydrate content of the final gel, which can be desirable to certain consumers.

The formulation includes an ionizing salt to provide the solution with sufficient cations to bond the carrageenan chains and form the gel network. In one embodiment, calcium gluconate, itself about 9% calcium by weight, is added in a ratio of water to calcium gluconate of at least about 68.5:1 by weight. Alternately, other ionizing calcium salts such as tri-calcium citrate, tri-calcium phosphate, calcium lactate, calcium carbonate, calcium hydroxide, calcium chloride, or an aqueous calcium ion solution can be substituted. Calcium citrate does not introduce any carbohydrates to the gel as calcium gluconate does. However, calcium, in particular calcium gluconate, is considered to provide superior gel characteristics, at least because of the divalent properties of the calcium cation. Moreover, the amount of carbohydrate introduced by the calcium gluconate is considered negligible. Calcium is also preferred because it provides a desirable nutritional supplement. Alternately, salts based on magnesium, potassium or sodium, or aqueous ion solution containing on ore more of these can be substituted.

Furthermore, calcium gluconate, e.g., according to the preferred embodiment, when used in the present invention composition, does not render the compositions non-transparent. Generally, calcium additives in food products yield a cloudy appearance in the final product. However, when using for example calcium gluconate, the calcium in solution and ultimately the final gel does not detract from the transparency of the final product.

Though not generally affecting the physical characteristics of the gel, and non-essential to the formulation of a gel, certain other ingredients can be added. For example, artificial and/or natural, ‘ANN’ as known to those in the art, color and or flavors can be added. Natural sweeteners, including sucrose, glucose, fructose, high-fructose corn syrup and/or fruit juices, among others, can be added. Alternately, reduced carbohydrate sugar substitutes can be used. Among these are sucralose (for example, marketed under the brand name SPLENDA), ace-K sulfamate, sorbitol, saccharine, or aspertame (for example, marketed under the brand name NUTRASWEET). The above comprises a non-limiting sample list of artificial or natural sweeteners approved by the FDA for human consumption.

Natural sweeteners generally require greater quantity to achieve a suitable sweetness than their artificial counterparts do. Although neither directly affects the gelling characteristics of the final product, the amount of sweetener reduces the percentage of water in the final product. Therefore, where the final product is packaged for sale by volume, the amount of carrageenan required per serving is increased when using artificial sweeteners as opposed to natural, because the proportion of water is increased for a given volume.

Certain other additives can be introduced, for example whey protein. Though having beneficial nutritional aspects, it introduces a cloudy appearance to the final product. With a reduced carrageenan content, yielding a weaker gel, the product can be suitable a ‘smoothie’-type beverage.

Furthermore, although the invention contemplates application as a dessert or snack food item, it is not limited to that application. For example, the product can be used as a pharmaceutical or nutraceutical delivery vehicle. Contemplated additives include pharmaceutical compounds, nutrients, vitamins, proteins and DNA, among others. Any water-soluble additive can simply be dissolved in solution for inclusion in the gel. If a desired ingredient is insoluble in water, an inverse (micro) emulsion can be formed, trapping the particles of the desired ingredient in micelle of the emulsion. Alternately, globular material can be locked into the gel structure, and/or ground particles of a water-insoluble material can be suspended in a liquid form of the gel and fixed when the gel solidifies.

A preferred method of producing the gelatin begins with an iota form of carrageenan. The iota carrageenan can be in fibrous form, or more preferably, in a liquid extract form. The iota carrageenan is dissolved in water held in a vessel. For example, the vessel can be a jacketed vessel where steam or hot oil can be introduced within the jacket to heat the contents of the vessel. An agitator can be introduced in the vessel, as it is desirable to agitate the mixture during the process.

Sweeteners known in the art and/or set forth above, can also be introduced at the initial stage. In one embodiment, when using granular sweeteners in combination with carrageenan, the granular sweeteners and carrageenan can be premixed, which can aid in the dispersal of the carrageenan in the water. Agitation is desirable during the heating process, preferably at a rate of about 60-90 RPM, to aid in dissolving the carrageenan in solution.

As the carrageenan and water increase in temperature, the viscosity noticeably increases as the mixture passes through about 150°-155° F. With further increase in temperature, up to about 180° F., the viscosity of the mixture reduces as the carrageenan is fully dissolved into solution. At this point, any desired flavors and/or pigments can be added and dispersed.

Additionally, citric acid (vitamin C), for example, can be added. In addition to providing a nutritional supplement, citric acid gives the product a desirable tart flavor. It also reduces the pH of the mixture. Under FDA regulations, any product having a pH below 4.5 is considered a high-acid product, and does not require additional bacterial protection, for example retorting. More commonly in the food industry, and preferably according to the present invention, the target pH of the product is reduced to about 3.0. Additionally, artificial sweeteners add nearly no carbohydrates to the product to serve as a food source for any mold, bacteria, yeast, or other biological contaminants, further reducing the probability of the growth of such contaminants and improving the shelf life of the product. In substitution of or in addition to citric acid, malic acid, ascorbic acid, or any other pH-lowering additive approved by the FDA for human consumption can be substituted.

It is preferable that the citric acid or other pH reducing agent be added to the product as nearly as practicable before the gel is solidified. In the liquid state, the acid breaks down the polysaccharide chain of the carrageenan, reducing the gel strength. However, this is only a concern while in the liquid state, because breakdown of the polysaccharide chain does not continue after the gel solidifies. The acid can be introduced into the mixing vessel soon before the mixture is portioned and filled into containers for cooling. Alternately, the acid can be flow-mixed as the containers are filled. In the latter case, gel texture is consistent across the entire batch, since no portion of the batch spends more time in a liquid state with the acid than any other portion. Additionally, if filling of the batch is interrupted for any reason, the portion of the batch remaining unfilled is not susceptible to deterioration by prolonged exposure to the acid in a liquid state.

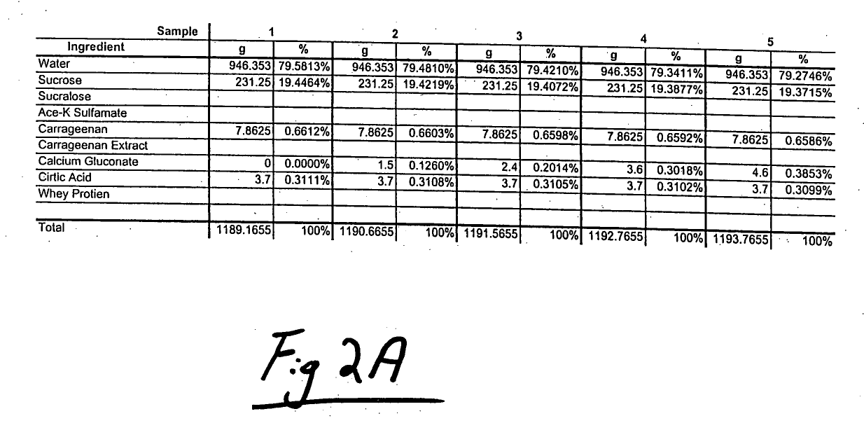

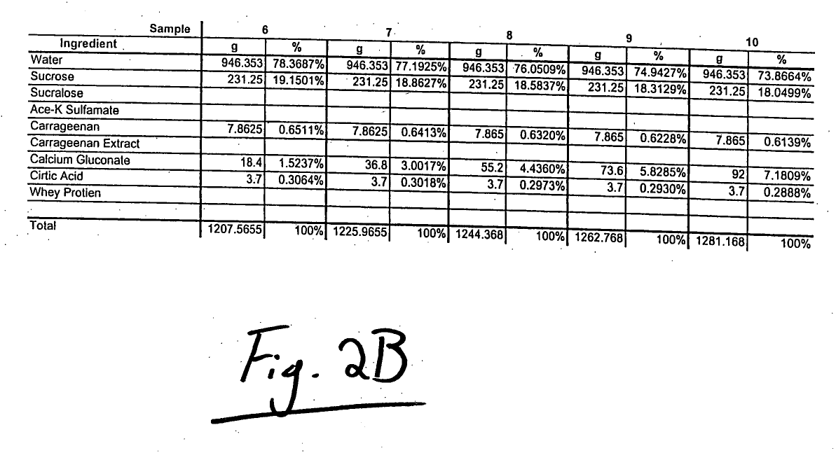

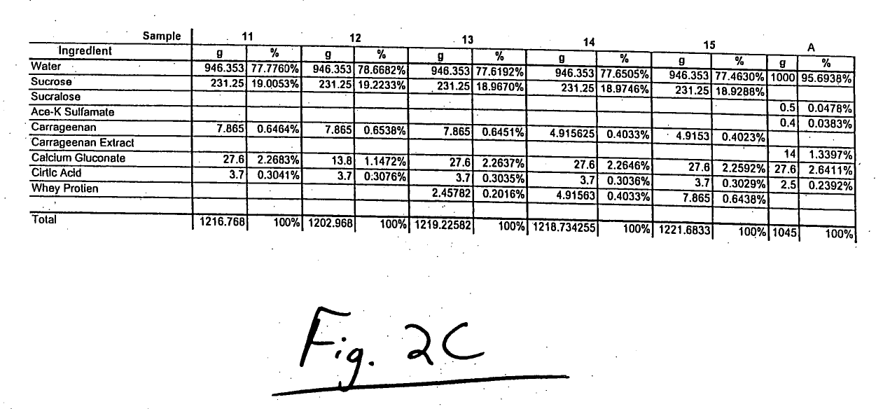

Referring now to FIGS. 2A-2C, shown in tabular form are the compositions of various. sample formulations according to the present invention. Characteristics of the results varied. For example, sample 1 did not solidify to a gel at room temperature. Samples 2-5 formed only a weak gel. Samples 6-12 each formed a suitable gel. Samples 6-12 differ primarily in their concentration of calcium. Samples 13-15 each included whey protein. Of samples 13-15, only 13 formed a suitable solid gel; samples 14-15 were each weak gels. Samples 1-15 all used sucrose as a sweetener. Sample 12 used the lowest proportion of calcium gluconate among those listed in the figures. The ratio of water to carrageenan to calcium in sample 12 is about 760:6.33:1 by weight. However, a suitable gel would hold with as little as half that amount. In that case, the ratio of water to carrageenan to calcium would be about 1524:12.67:1 by weight.

Expressed in other terms, according to the present invention an aqueous solution has carrageenan sufficient to support a gel network and a molar concentration of cation linking the gel network. Cation. concentration of at least 0.0025 molar percent (2.5×10⁻⁵ molar), in de-ionized water, begins to show thickening. This corresponds to a gram-molar ratio of calcium cation to carageenan of at least about 1:100. Bottled-quality spring water exhibits minimal thickening without the addition of any cation. However, the texture achieved at these levels of cation concentration would not be considered suitable for a shelf. stable gel product, but rather a exhibits the consistency of a yogurt, and is therefore suitable for use in a ‘smoothie’-type drink, as described above. Additionally, it is observed that the temperature at which the gel transitions from liquid to gel/solid state varies inversely with cation concentration.

Sample A is a sugar-free and low carbohydrate formulation. Carrageenan extract is used in place of fibrous carrageenan. Note the increased percentage of carrageenan, necessitated to hold a gel with the increased proportion of water. The ratio of water to carrageenan to calcium in sample A is about 402.6:5.636:1 by weight. Carrageenan extract can be reduced as low as 1% in sample A and still achieve a suitable gel consistency. In that case, the ratio of water to carrageenan to calcium would be at least about 402:4.22:1 by weight. Sample A comprises about 95.69% wt. water, about 1.34% wt. iota carrageenan extract, about 2.64% wt. calcium gluconate about 0.24% wt. citric acid about 0.0383% wt. Ace-K sulfamate, and about 0.0478% wt. sucralose.

The present invention has been described herein with reference to certain exemplary and/or preferred embodiments. Some alterations and/or modifications will be apparent to those skilled in the art in light of the present disclosure.

1. A gel formulation consisting essentially of:
an aqueous solution having at least 0.6% wt. of carrageenan, to support a gel network; and
a cation in a gram-molar concentration of at least 0.0025 percent; and
optionally one or more non-essential additives.

2. The gel formulation according to claim 1 wherein the cation is a divalent cation.

3. The gel formulation according to claim 1 wherein the cation is derived from an ionizing salt.

4. The gel formulation according to claim 3 wherein the ionizing salt comprises one or more salts of calcium, potassium, magnesium, and sodium.

5. The gel formulation according to claim 3, wherein the ionizing salt comprises one or more of tri-calcium citrate, tri-calcium phosphate, calcium lactate, calcium carbonate, and calcium hydroxide, calcium chloride.

6. The gel formulation according to claim 1 wherein the cation is derived from an aqueous cation solution.

7. The gel formulation according to claim 1, wherein the carrageenan is a liquid extract of carrageenan.

8. The gel formulation according to claim 1 wherein the carrageenan is an iota form of carrageenan.

9. The gel formulation according to claim 1, having a pH of below about 4.5.

10. The gel formulation according to claim 9, having a pH of about 3.0.

11. A gel formulation consisting essentially of:
at least about 73.8% wt. water;
at least about 0.6% wt. carrageenan;
at least about 0.57% wt. calcium gluconate; and
optionally one or more non-essential additives.

12. The gel formulation according to claim 11, wherein the carrageenan is a liquid extract of carrageenan.

13. The gel formulation according to claim 11 wherein the carrageenan is an iota form of carrageenan.

14. The gel formulation according to claim 11, wherein at least one non-essential additive comprises between about 0.075% wt. and about 20% wt. of a sweetener.

15. The gel formulation according to claim 14, wherein the sweetener comprises one or more selected from among the group comprising sucrose, glucose, fructose, high-fructose corn sweetener, fruit juice, aspertame, sucralose, sorbitol, saccharine, and Ace-K sulfamate.

16. The gel formulation according to claim 14, wherein the sweetener comprises an artificial or natural sweetener approved by the FDA for human consumption.

17. The gel formulation according to claim 11, wherein at least one non-essential additive comprises at least about 0.014% wt of one or more of citric acid, ascorbic acid, malic acid, or a pH-lowering compound approved by the FDA for human consumption.

18. The gel formulation according to claim 11, having a pH of below about 4.5.

19. The gel formulation according to claim 18, having a pH of about 3.0.

20. The gel formulation according to claim 11, wherein at least one non-essential additive comprises a coloring.

21. The gel formulation according to claim 11, wherein at least one non-essential additive comprises a flavoring.

22. The gel formulation according to claim 11, wherein at least one non-essential additive comprises whey protein.

23. The gel formulation according to claim 11, wherein at least one non-essential additive comprises one or more selected from the group comprising pharmaceutical compounds, nutrients, vitamins, proteins and DNA.

24. A gel formulation consisting essentially of water, carrageenan, and calcium in a ratio of at least about 1520:12.6:1 by weight.

25. The gel formulation according to claim 24, wherein the calcium is derived from calcium gluconate.

26. A gel formulation consisting essentially of water, iota carrageenan extract, and calcium in a ratio of at least about 402:4.22:1 by weight.

27. The gel formulation according to claim 26, wherein the ratio of water, iota carrageenan extract, and calcium is at least about 402.6:5.636:1 by weight.

28. A gel formulation consisting essentially of:
about 95.69% wt. water;
about 1.34% wt. iota carrageenan extract;
about 2.64% wt. calcium gluconate;
about 0.24% wt. citric acid;
about 0.0383% wt. Ace-K sulfamate; and
about 0.0478% wt. sucralose.
